(19) United States
(12) Patent Application Publication
(10) Pub. No.: US 2023/0025882 A1
(43) Pub. Date: Jan. 26, 2023

(54) FLUID LIMIT VENT VALVE WITH SPLASH PREVENTION

(71) Applicant: Toyoda Gosei Co., Ltd., Kiyosu-Shi (JP)

(72) Inventors: Caleb S. Bauer, Troy, MI (US); Kenta Kuwayama, Inazawa (JP); Yasushi Tashiro, Inazawa (JP); Steven Yurgalonis, Troy, MI (US)

(21) Appl. No.: 17/383,600

(22) Filed: Jul. 23, 2021

(51) Int. Cl. F16K 24/04; B60K 15/035

(52) U.S. Cl. CPC F16K 24/044; B60K 15/035; B60K 2015/03256

(57) ABSTRACT

A fluid limit vent valve assembly includes a lower case having a base portion and an outer wall extending from the base portion to define a lower case interior cavity and an opening at an end of the lower case opposite the base portion. A first slot extends through the outer wall. A fuel flow diverter is positioned in the interior cavity directly opposite first slot and extends along a path between the first slot and a vapor exit passage of the valve assembly. The flow diverter prevents splashing of liquid fuel into a vapor exit passage of the valve assembly. A second slot also extends through the lower case outer wall and is angularly spaced apart from the first slot.

The subject matter described herein relates to valves for controlling flow of liquids and, more particularly, a fluid limit vent valve positionable in a fuel tank of a vehicle to prevent an overfill or overflow condition in the fuel tank.

### BACKGROUND

A fluid limit vent valve (FLVV) may be mounted in a vehicle fuel tank to prevent overflow of the fuel tank during vehicle re-fueling. The valve may use a float system to close the valve before the maximum fuel tank capacity is reached. Closing of the valve may create a back-pressure condition in the fuel tank that triggers an automatic stoppage of the re-fueling pump. An interior of the valve may be in fluid communication with a vapor passage designed to allow fuel vapor to exit the valve and the fuel tank. The exiting vapor may be directed to a canister including a charcoal filter element designed to filter the fuel vapors.

In a valve assembly structured to admit fuel into the valve through an opening in a side wall of the case, a portion of the fuel entering the opening may splash and be deflected upwardly while the valve is open, thereby admitting liquid fuel into the vapor passage before the valve can close. If liquid fuel enters the vapor passage and comes in contact with the vapor filter, it may damage the filter, which is designed only for contact with fuel vapor and not for contact with fuel in liquid form.

### SUMMARY OF THE INVENTION

In one aspect of the embodiments described herein, a fluid limit vent valve assembly is provided for controlling liquid fuel flow into a fuel tank. The valve assembly includes a lower case having a base portion and an outer wall extending from the base portion to define a lower case interior cavity and an opening at an end of the lower case opposite the base portion. A first slot extends through the outer wall. A fuel flow diverter is positioned in the interior cavity directly opposite first slot and along a path between the first slot and a vapor exit passage of the valve assembly. A second slot extends through the outer wall and angularly spaced apart from the first slot.

### BRIEF DESCRIPTION OF THE DRAWINGS

The accompanying drawings, which are incorporated in and constitute a part of this specification, illustrate embodiments described herein and together with the description serve to explain principles of embodiments described herein.

FIG. 1 is a schematic perspective view of a valve assembly incorporating a liquid fuel flow diverter in accordance with an embodiment described herein.

FIG. 2 is a schematic side view of the valve assembly shown in FIG. 1.

FIG. 3A is a schematic exploded view of the valve assembly shown in FIGS. 1 and 2.

FIG. 3B is a schematic exploded view of a float assembly in accordance with an embodiment described herein and structured to be incorporated into the valve assembly shown in FIGS. 1-3A.

FIG. 4 is a schematic cross-sectional side view of the valve assembly shown in FIGS. 1 and 2.

FIG. 4A is schematic cross-sectional side view of an alternative valve assembly similar to the assembly shown in FIG. 4, but showing an alternative arrangement of a liquid fuel flow diverter.

FIG. 5 is a schematic cross-sectional side view of a lower case in accordance with an embodiment described herein.

FIG. 6A is the cross-sectional view of FIG. 4 illustrating exemplary flow paths of fuel vapor and liquid into the interior of the valve assembly via holes and slots formed in the lower case.

FIG. 6B is a schematic cross-sectional plan view of the lower case of FIG. 5 further illustrating the liquid and vapor fuel flow paths into and within the lower case as shown in FIG. 6A.

FIG. 6C is another schematic cross-sectional plan view of the lower case of FIG. 6B, again showing the liquid and vapor fuel flow paths into and within the lower case, and also showing an angular extent of an embodiment of the liquid fuel flow diverter.

FIG. 7A is a schematic cross-sectional side view similar to FIG. 4 showing the valve assembly in a completely open condition just as fuel begins to enter the lower case through the lower case base portion hole.

FIG. 7B is the schematic cross-sectional side view of FIG. 7A showing the valve assembly as the liquid fuel level in the lower case interior rises and the buoyant force acting on the float assembly gradually increases.

FIG. 7C is the schematic cross-sectional side view of FIGS. 7A-7B showing the float assembly of the valve having risen off a floor of the lower case and with the upper float making contact with the upper case as the fuel level in the lower case rises.

FIG. 7D is the schematic cross-sectional side view of FIGS. 7A-7C showing each of the fuel vapor pathways out of the top of the valve assembly in a blocked or closed condition (thereby placing the valve assembly in a fully closed condition) as the fuel level has continued to rise.

FIG. 7E is a schematic side cross-sectional view of the valve assembly similar to the view of FIG. 7D, with the valve assembly tilted at an angle of 4° to a vertical plane.

FIG. 7F is a schematic side cross-sectional view of the valve assembly similar to the view of FIG. 7D, with the valve assembly tilted at an angle of −4° to a vertical plane.

FIG. 8A is a view similar to that shown in FIG. 7D showing the valve assembly beginning to open after the lower case internal fluid level has dropped below the slots, with the lower float separating from the middle float and beginning to exert a downward pressure on the middle float.

FIG. 8B is the schematic cross-sectional side view of FIG. 8A showing the middle float separated and spaced apart farther from the upper float seal (thereby opening the fuel vapor path between the middle float and the upper float) as the fuel level further continues to drop.

FIG. 8C is the schematic cross-sectional side view of FIGS. 8A-8B showing the upper float seal separated from the upper case, thereby re-opening the vapor flow passage between the upper float seal and the upper case as the fuel level further continues to drop and the valve assembly continues to open.

### DETAILED DESCRIPTION

A fluid limit vent valve assembly is provided for controlling liquid fuel flow into a fuel tank, to prevent an overfill or overflow condition in the fuel tank. The valve assembly includes a lower case having a base portion and an outer wall extending from the base portion to define a lower case interior cavity and an opening at an end of the lower case opposite the base portion. A first slot extends through the outer wall. A fuel flow diverter is positioned in the interior cavity directly opposite first slot and extends to a location between the end opening and an edge of the first slot closest to the end opening. The flow diverter may be formed contiguously with (i.e., as an extension of) an inner wall of the lower case designed to contain a float assembly of the valve assembly. The flow diverter prevents splashing of liquid fuel into a vapor exit passage of the valve assembly. A second slot also extends through the lower case outer wall and is angularly spaced apart from the first slot. A float assembly is positioned in the lower case and includes lower, middle, and upper floats structured to be movable independently of each other responsive to rising and falling liquid fuel levels in the lower case, to close and open various fuel vapor exit passages formed inside the valve assembly.

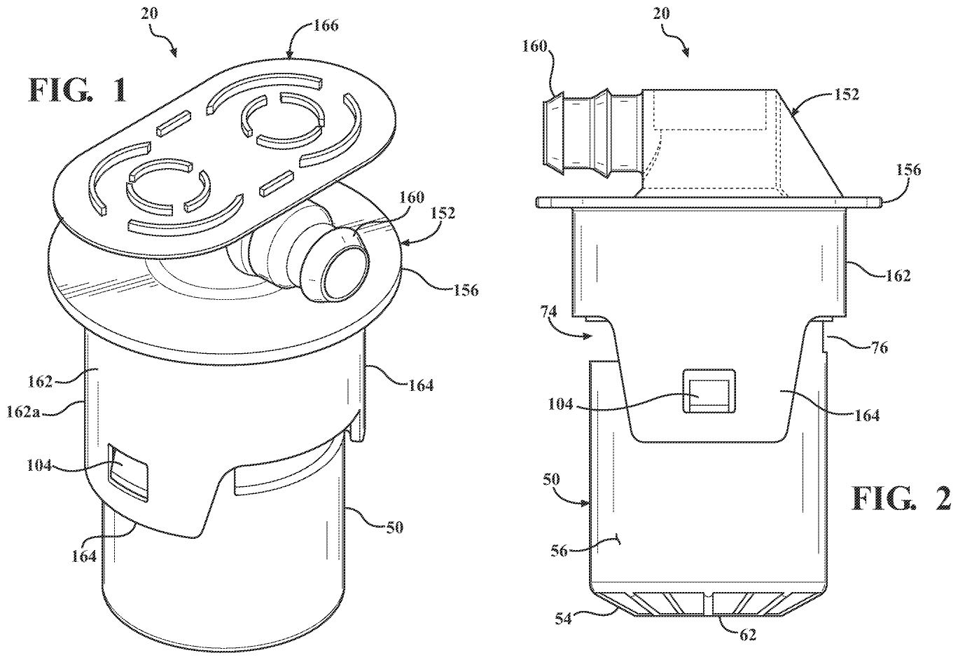

Referring to FIGS. 1-6C, the valve assembly 20 may have a lower case 50. The lower case 50 may include a base portion 54 and a cylindrical outer wall 56 extending from the base portion 54 to define an interior cavity 58 of the lower case. The outer wall 56 may also define an end opening 60 of the lower case residing opposite the base portion 54. The base portion 54 may have a through hole 62 formed therein to facilitate fuel flow into and out of the interior cavity 58. The hole 62 may be sized to provide a desired flowrate of liquid fuel into the lower case interior. In one or more arrangements, the base portion through hole 62 may have a diameter in the range 1.7 millimeters±0.4 millimeters. The base portion hole 62 may lead from an exterior of the lower case 50 into a funneled or chamfered section 64 of the base portion 54 designed to distribute liquid fuel entering the hole 62 radially outwardly so that the rising liquid fuel level will contact the core float 66 and the lower float 68 (described in greater detail below) and begin to exert buoyant forces on the core float and the lower float substantially simultaneously. The chamfered section 64 may terminate in a floor 70 of the base portion 54 on which the lower float 68 may rest when the valve assembly is in an open condition and with little or no liquid fuel contained with the lower case 50.

In one or more arrangements, the floor 70 may include standoffs 70t extending from a surface 70s thereof, to enable fuel rising above the chamfered section 64 to enter the lower case interior cavity 78 underneath the lower float 68.

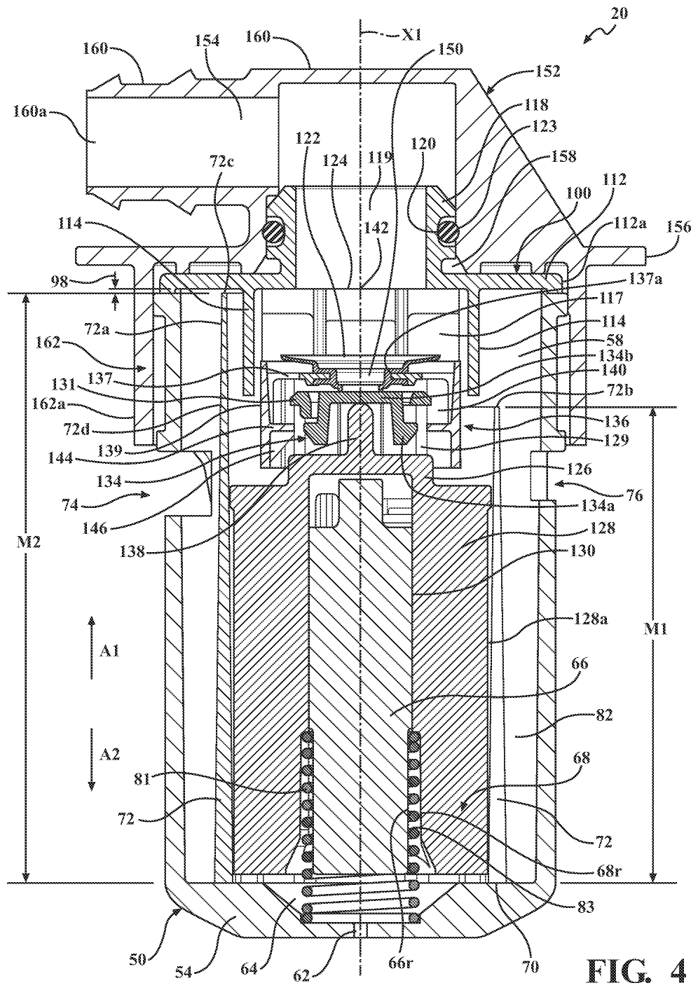

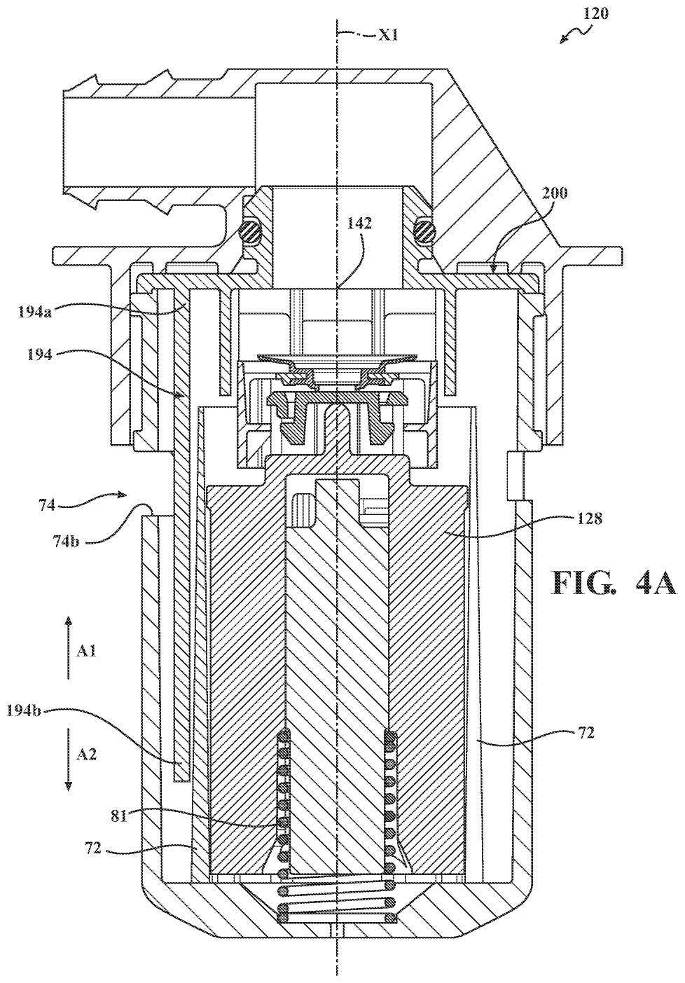

Referring to FIGS. 4, 5 and 6B, a first slot 74 may extend through the outer wall 56 to enable fuel to enter the interior cavity 58 of the lower case 50. First slot 74 may provide a primary path for flow of liquid fuel and fuel vapor to flow into the lower case interior cavity 58. In one or more arrangements, the first slot 74 may be rectangular and may have a width W1. Slot width W1 may be specified so as to enable a fuel flow rate of at least a predetermined amount into the lower case interior when the fuel level in the fuel tank reaches the slot 74, so that the lower case interior will fill relatively rapidly with fuel when this fuel level is reached. The actual slot width W1 used for a particular application may be determined analytically and/or iteratively, through experimentation and testing.

A lower case second slot 76 may also extend through the outer wall 56 and may be angularly spaced apart from the first slot 74. Second slot 76 may provide a secondary path for flow of liquid fuel and fuel vapor to flow into the lower case interior cavity. Second slot 76 may alternatively provide a path for flow of liquid fuel and fuel vapor to flow out of the lower case interior, thereby performing a fuel venting function. In one or more arrangements, the second slot 76 may be rectangular and may have a width W2. In one or more arrangements, the second slot width W2 may be less than the first slot width W1.

Referring to FIGS. 4, 6B, and 7E-7F (described in greater detail below), the slot width W2 may be specified so as to enable a fuel flow rate of at least a predetermined amount out of the lower case interior when the valve assembly 20 is tilted from the vertical condition of FIG. 4 to an angle of ±4° with respect to the vertical plane X4 extending through central axis X1. This helps ensure rapid response of the lower case internal fuel level to changes in the tank fuel level (i.e., the lower case exterior fuel level).

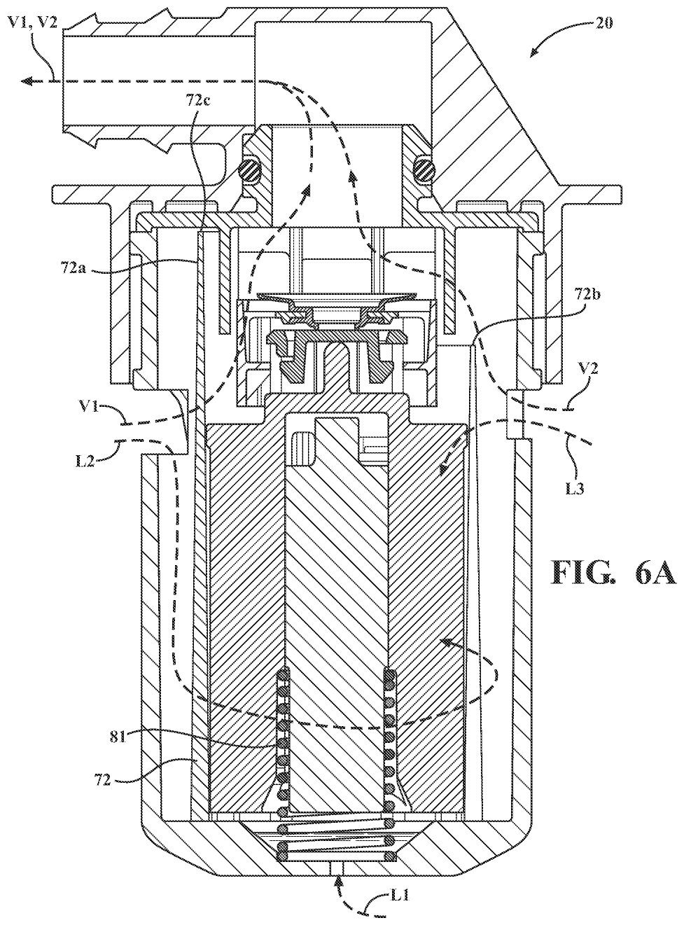

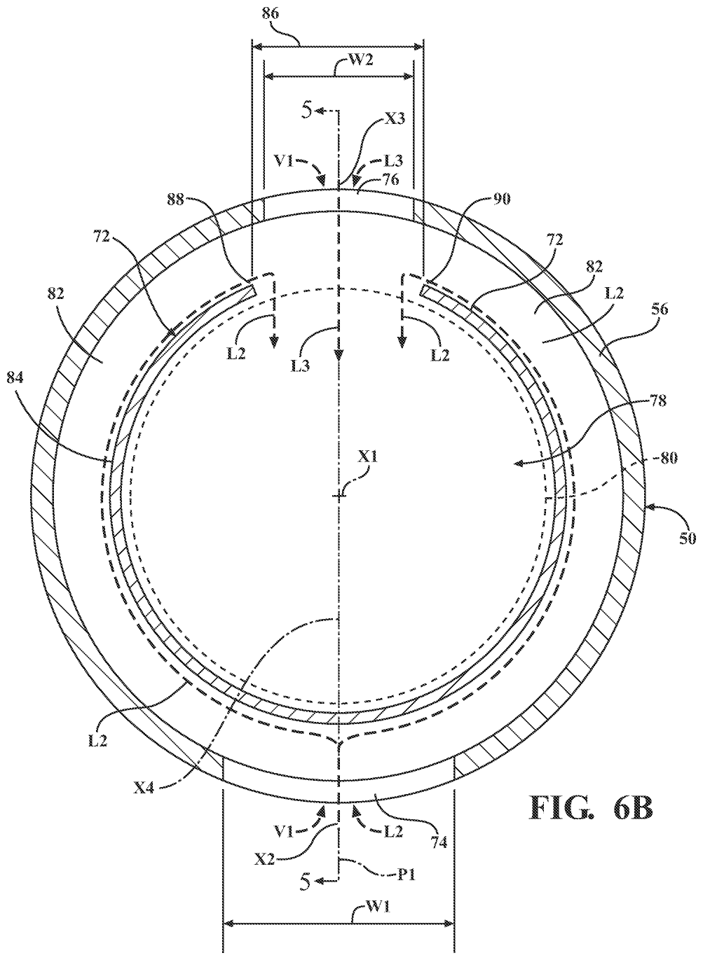

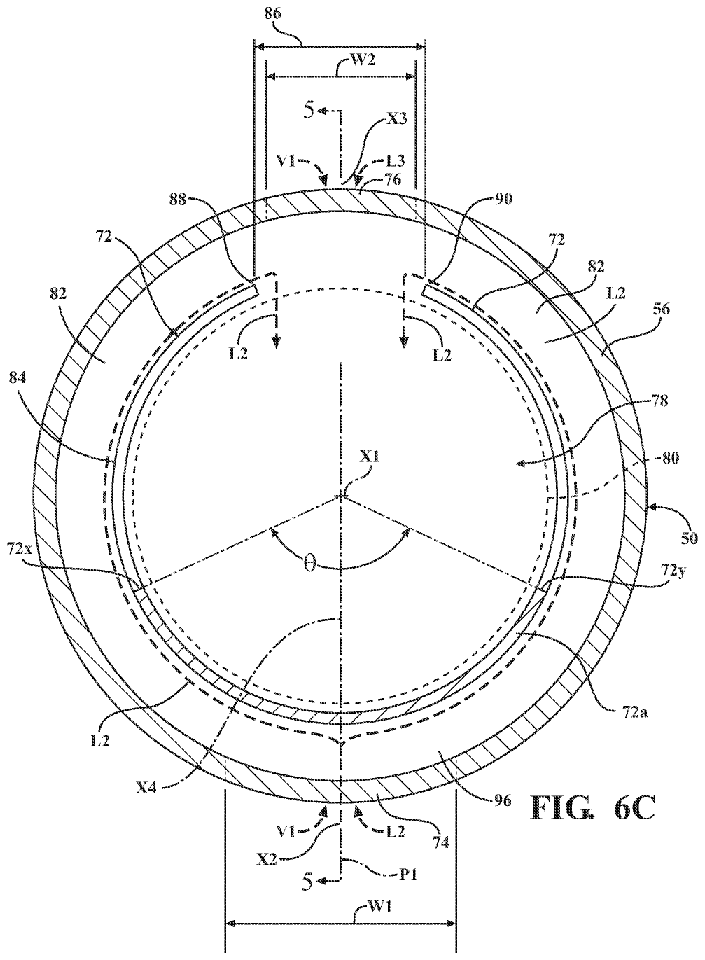

Referring to FIG. 6B, in particular arrangements, a plane X3 bisecting the second slot 76 and extending through the longitudinal central axis X1 of the lower case 50 may be angularly spaced apart a distance of 180°±5° from a plane X2 bisecting the slot 74 and extending through the longitudinal central axis X1 of the lower case 50. Thus, in such a case, the planes X2 bisecting slot 74 and X3 bisecting slot 76 may be coplanar along a common plane X4.

In addition, first and second slots 74, 76 may be structured and positioned so that liquid fuel entering the lower case through either of the slots will enter through the first slot 74 prior to fuel entering the second slot 76 when the valve assembly 20 is in a vertical orientation and not tilted, as shown in FIG. 4 (i.e., a lowermost edge 74b of the first slot 74 may be vertically lower than a lowermost edge 76b of the second slot 76 when the valve assembly 20 is in the vertical orientation). In one or more arrangements, a first edge 74a of the first slot 74 and a first edge 76a of the second slot 76 may reside at the same vertical level when the valve assembly 20 is in the vertical orientation.

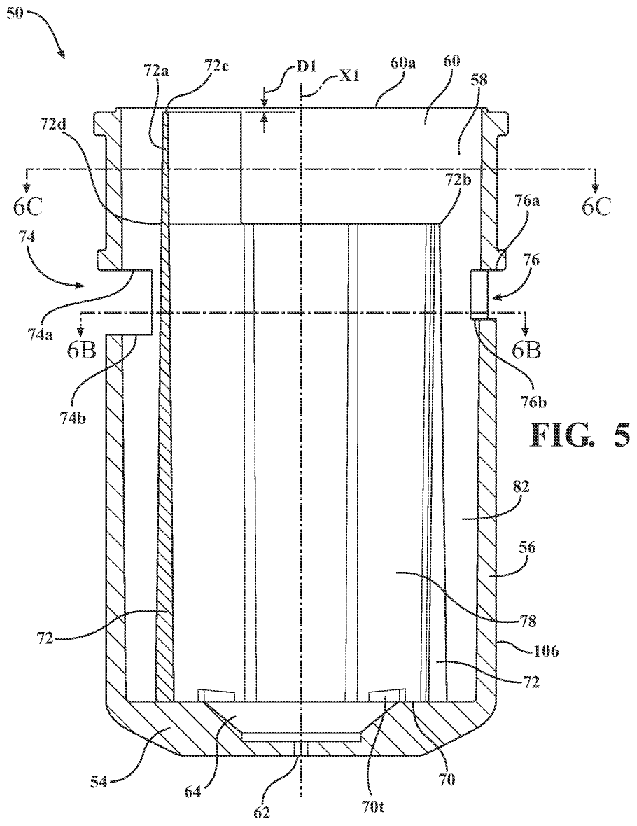

Referring in particular to FIGS. 5 and 6B, a semi-cylindrical inner wall 72 may extend from the base portion 54 to a location proximate the first and second lower case slots 74, 76. Inner wall 72 may define a cavity 78 structured to receive therein elements of the float assembly 80 (described below) and to enable the lower float 68 and other floats described herein to move freely within the cavity 78 during operation of the valve assembly. Inner wall 72 may be structured to surround the base portion chamfered section 64 leading into the base portion hole 62. In one or more arrangements, the inner wall 72 may be formed as a single piece with the base portion 54.

Inner wall 72 may also be structured to form (in conjunction with outer wall 56) a liquid fuel flow channel 82 designed to direct fuel entering lower case first slot 74 along an exterior surface 84 of the inner wall 72 until an inner wall gap 86 is reached. To this effect, the inner wall 72 may be continuous between opposed edges 88, 90 of the inner wall gap 86 as shown in FIG. 6B. The inner wall gap 86 may be structured to admit liquid fuel into the cavity 78, thereby exposing the float assembly 80 in the cavity 78 to the quantity of liquid fuel entering the lower case through first and second slots 74, 76. As seen in FIGS. 5 and 6B, the inner wall gap 86 may be angularly spaced apart from the lower case first slot 74. In one or more arrangements, the inner wall gap 86 may extend an entire length of the inner wall 72, from the base portion floor 70 to an uppermost edge or end 72b of the inner wall at height M1 (FIG. 4).

Referring in particular to FIGS. 5 and 6C, a fuel flow diverter 72a may be positioned in the lower case interior cavity 58 directly opposite first slot 74. In one or more arrangements, the flow diverter 72a may be semi-cylindrical (i.e., the diverter may have the shape of a portion of a cylinder). The flow diverter 72a may be a wall section spaced apart from the outer wall 56 so as to form a fuel flow channel 96 extending between the outer wall 56 and the flow diverter 72a. The fuel flow channel 96 may intersect and blend into the fuel flow channel 82 previously described. The flow diverter 72a may be positioned along a path between the slot 74 and a vapor exit passage 119 of the upper case 100 (described in greater detail below). In one or more arrangements, the fuel flow diverter may be formed contiguously with the inner wall 72 (i.e., as an extension of or as a single piece with the inner wall) and so as to extend from the uppermost edge 72b of the inner wall 72.

As seen in FIG. 5, the flow diverter 72a may extend to a location between the lower case end opening 60 and the first edge 74a of the first slot closest to the lower case end opening 60. In particular arrangements, the flow diverter 72a may extend from a first end 72d intersecting the inner wall 72 along its uppermost edge 72b at height M1, to a second end 72c opposite the first end 72d and residing at height M2, at the location between the lower case end opening 60 and the edge 74a of the first slot 74 closest to the lower case end opening 60. In particular arrangements, the flow diverter 72a may be structured to extend to a distance D1 within a range of 0-4 millimeters from an edge 60a of the lower case end opening 60. Such an arrangement provides an air gap 98 between the flow diverter 72a and the valve assembly upper case 100 (described below) when the upper case is secured to the lower case 50. In particular arrangements the flow diverter 72a may be structured to extend to a distance within a range of 0-2 millimeters from the upper case base portion 102 (described below).

Also, as shown in FIG. 4, the inner wall 72 may extend from the floor 70 a distance M1 to the uppermost edge 72b of the inner wall. In addition, the end 72c of the flow diverter may extend a distance M2 from the floor. In various particular arrangements, the distance M2 may remain constant while the distance M1 may be varied according to requirements of a particular design. With the flow diverter 72a positioned as described and its length maintained at the distance M2 from the floor, the structure and positioning of the flow diverter as described may prevent splashing of liquid fuel into the vapor passage regardless of the height of the inner wall 72.

In particular arrangements, as seen in FIG. 6C, the flow diverter 72a may extend through an arc length θ/2 in the range of 65°±5° to either side of a plane P1 extending along a longitudinal central axis X1 of the lower case 50 and including a central axis X2 of the first slot 74.

FIG. 4A shows an alternative arrangement 194 of the flow diverter. Referring to FIG. 4A, in alternative arrangements, the flow diverter 194 may be formed as a single piece with an alternative embodiment 200 of the upper case and may be supported only at the upper case base portion 112. The upper case 200 may otherwise have the same structure as the upper case 100 previously described. In one or more arrangements, the flow diverter 194 may be separate from (and spaced apart from) inner wall 72 and may be positioned between the outer wall 56 and the inner wall 72. As seen in FIG. 4A, in some arrangements, the flow diverter 194 may be structured to extend from the upper case to a location below a level of a lower edge 74b of the first slot 74. In particular arrangements, the flow diverter 194 may be structured from the upper case to a location approximately halfway between slot 74 and lower case floor 70.

Referring to FIGS. 1-3A, in one or more arrangements, the lower case 50 may include latching tabs 104 formed along an exterior surface 106 of the outer wall 56 and structured for engagement with complementary latching ears 108 formed on a valve assembly cover 110 as described below.

The lower case 50 may be formed from a polymer or any other suitable material or materials.

Referring again to the drawings, the valve assembly may include an upper case 100. The upper case may have a base portion 112. The upper case may be mountable or positionable over the lower case end opening 60 to close the lower case end opening 60 after the float assembly 80 has been positioned inside the inner wall interior cavity 78. In one or more arrangements, edges and/or sides of the upper case base portion 112 may be dimensioned so as to abut associated edges of the lower case outer wall 56, thereby closing the lower case first end.

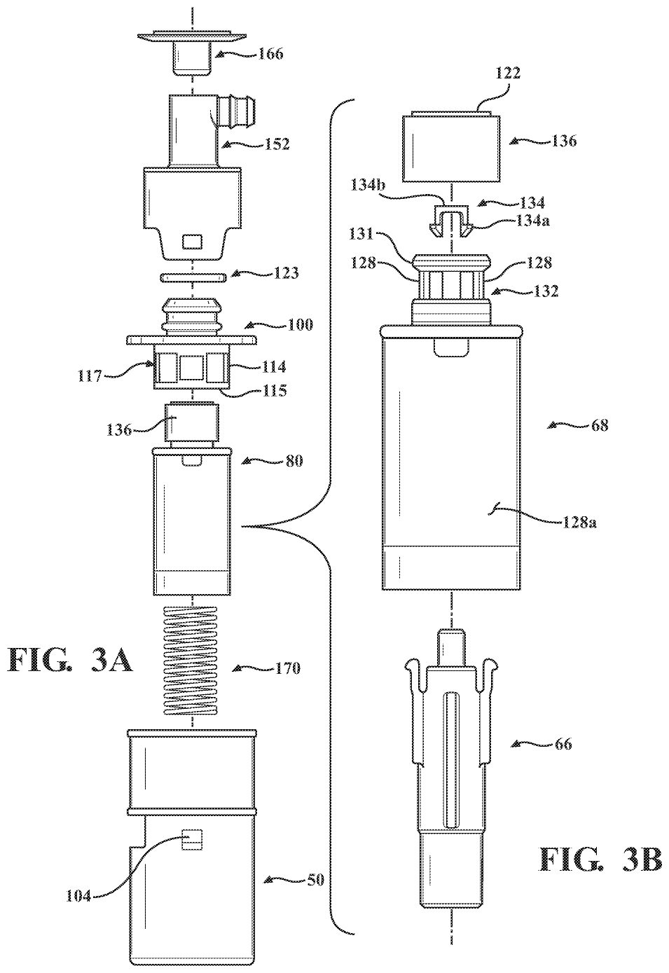

Referring to FIGS. 3A and 4, the upper case 100 may have multiple angularly spaced apart stalks 114 extending from base portion 112 along a first side of the base portion in a first direction, and extending into the lower case interior cavity 58 when the upper case is mounted on the lower case. An annular connecting member 115 may connect ends of the stalks 114. The stalks 114 and the connecting member 115 may combine to define a cylindrical cage structure 117 structured to receive the upper float 136 therein during operation of the valve assembly. Spaces between the stalks 114 may provide pathways for fuel vapor to exit the lower case 50 through the upper case base portion hole 124 when the upper float is spaced apart from the upper case 100.

The upper case 100 may also include a wall 118 extending from the base portion along a second side of the base portion opposite the first side, in a second direction opposite the first direction. The wall 118 may be structured to define a vapor exit passage 119 of the upper case 100. The wall 118 may be cylindrical. A groove 120 may be formed along an exterior surface of the wall 118 and configured to receive therein a resilient seal 123 (such as an O-ring or other gasket). In addition, a through hole 124 may be formed in the base portion 112 to enable fluid communication through the cage structure 117 between the lower case interior cavity 58 and the vapor passage 119.

Referring to FIGS. 3A, 3B, and 4, the valve assembly 20 may further include a float assembly 80. The float assembly 80 may include multiple connected floats structured to be securable to each other as described herein so as to prevent detachment of the floats from each other, yet movable with respect to each other during operation of the valve assembly. FIG. 3B is a schematic exploded view of a float assembly in accordance with an embodiment described herein.

In one or more arrangements, the float assembly 80 may include lower float 68 structured to be movable within the lower case interior cavity 58, a middle float 134 coupled to the lower float 68 so as to be movable with respect to the lower float, and an upper float 136 coupled to the lower float so as to be movable with respect to the lower float.

Referring to FIGS. 4 and 5, in one or more arrangements, the lower float 68 may be positioned within the lower case inner wall cavity 78. The lower float 68 may be structured to be movable within the cavity 78 defined by inner wall 72 in opposite directions A1 (closing direction) and A2 (opening direction) during operation of the valve assembly, to facilitate opening and closing of the valve assembly. The lower float 68 may include a base portion 126. A wall 128 may extend from the lower float base portion 126 along a first side of the base portion to define an interior cavity 130 of the lower float. The wall 128 may have a cylindrical outer surface 128a. Interior cavity 130 may be structured to receive a core float 66 therein.

Referring to FIGS. 3B and 4, series of angularly spaced apart supports 129 may extend from a second side of the lower float base portion 126 opposite the first side. A generally annular connecting portion 131 may connect the ends of the supports 129. The supports 129 and connecting portion 131 may combine to form a cylindrical cage structure 132 configured to receive and retain the middle float 134 (described below) therein. The annular connecting portion 131 may include a central opening structured to enable insertion of the middle float 134 into the cage structure 132 during assembly of the float assembly 80. In addition, each gap between a pair of adjacent supports 129 may be structured to receive therein a portion of an associated detent 134a formed on the middle float 134 when the middle float is positioned inside the cage structure 132. During operation of the valve assembly, the middle float 134 may be movable in directions A1, A2 with respect to the lower float 68, and the detents 134a may alternately abut and separate from the lower float connecting portion 131. Thus, the cage structure elements 129, 131 and the middle float 134 may be dimensioned to define and restrict the degree of movement of the middle float 134 within the cage structure 132 during operation of the valve assembly. Also, as described herein, by contact of the connecting portion 131 with the detents 134a, the lower float 68 may exert a force on the middle float 134 in the direction A2 to pull the middle float 134 out of contact with the upper float 136 as described herein.

Referring again to FIG. 4, a projection 138 may extend from the second side of the lower float base portion 126 and into the interior of the cage structure 132. Projection 138 may be structured to contact and exert a force on middle float 134 during operation of the valve assembly, to urge the middle float 134 into contact with an interior wall of the upper float 136 as described herein.

A recess 68r may be formed along a lower interior surface of the lower float interior cavity 130. The recess may be structured to reside opposite the recess 66r formed in the core float (described below) when the core float is inserted into the cavity 130 during assembly of the float assembly.

The lower float 68 may be formed from a polymer or any other suitable material or materials.

A core float 66 may be received in lower float interior cavity 130. When positioned within the interior cavity 130, the core float 66 may be positioned so that liquid fuel entering the lower case interior cavity 58 through lower case base portion hole 62 contacts the core float 66 and exerts an upwardly acting buoyant force on the core float as the fuel level rises inside the lower case. The core float 66 may be formed from a polymer or any other suitable material or materials. The core float 66 may be formed using a material having a relatively higher buoyancy per unit volume than the material from which the lower float 68 is formed. A recess 66r may be formed in a surface of the core float 66 along a lower end of the float. The recess may be structured reside opposite the recess 66r formed in the lower float when the core float is inserted into the cavity 130 during assembly of the float assembly. In combination, the recesses 66r, 68r may form a cavity 83 structured to receive therein a spring member 81 (described in greater detail below).

The middle float 134 may include a base portion 134b and two or more resiliently deflectable detents 134a. In one or more arrangements, the detents 134a may be equi-angularly spaced apart and may be structured to extend from the middle float base portion 134b in a direction A2 toward the lower case base portion 54 when the middle float 134 is positioned inside the lower case cage structure 132. The middle float 134 may be structured to be movable within the lower float cage structure 132 in opposite directions A1 and A2 during operation of the valve assembly, to facilitate opening and closing of the valve assembly as described herein. The middle float 134 may be formed from a polymer or any other suitable material or materials.

Upper float 136 may be structured to be received within the upper case cage structure 117. The upper float 136 may be structured to be movable within the upper case interior cage structure 117 in opposite directions A1 and A2 during operation of the valve assembly, to facilitate opening and closing of the valve assembly. The upper float 136 may have a base portion 137 and a cylindrical outer wall 139 extending from edges of the base portion 137 to define an interior cavity 140 of the upper float.

The upper float base portion 137 may include a first opening 137a structured to receive at least a portion of a resilient annular seal member 122 therein. A ledge 144 may extend from outer wall 139 into upper float interior cavity 140. The ledge 144 may be continuous (i.e., unbroken) along a 360° extent of an interior surface of the wall 139. Supporting gussets 146 may extend from the wall interior surface to ledge 144 to support the ledge against forces exerted thereon. The gussets 146 may be angularly interspersed along the wall interior surface to support the ledge 144 against forces exerted on the ledge by the lower float as described herein.

The upper float 136 may be formed from a polymer or any other suitable material or materials.

The annular seal member 122 may define a passage 150 therethrough. The passage 150 may be structured to be in fluid communication with the upper float interior cavity 140 to enable a flow of fuel vapor from the upper float interior cavity 140 through the first opening 137a formed in upper float base portion 137. The seal member 122 may be structured to abut the middle float base portion 134b during operation of the valve assembly, to close and seal the upper float first opening 137a and prevent a flow of vapor from the upper float interior cavity 140 through the first opening 137a and into the upper case vapor passage 119.

Resiliently deformable seal member 122 may be received and secured within the base portion first opening 137a. The seal member 122 may be formed from a bonded rubber or similar material flexible enough to seal the upper case base portion hole 124 when the seal abuts the upper case base portion 112 under pressure and covers the upper case base portion hole 124, thereby sealing the upper case vapor passage 119.

Referring to FIGS. 1-4, a cover 152 may be secured to the lower case 50 to secure the upper case 100 to the lower case 50 and to further extend the vapor flow path toward the filter canister (not shown). The cover 152 may define a flow passage 154 for fuel vapor exiting the valve lower and upper cases.

The cover 152 may have a base portion 156. The cover base portion 156 may define a first cover opening 158 at a first end of the vapor flow passage 154. The first cover opening 158 may lead from the upper case 100 into the flow passage 154.

An upper body portion 160 may extend from the base portion 156 in a first direction. The first cover opening 158 and upper body portion 160 may be structured to receive therein the second wall 118 of the upper case 100. When the upper case second wall 118 is inserted into the first cover opening 158, a resilient seal 123 applied to the exterior of the upper case second wall 118 may sealingly contact interior walls of the cover upper body portion 160 to form a gas-tight seal between the upper case second wall 118 and the cover upper body portion 160. The upper body portion 160 may also include a vapor outlet nozzle 160a. The vapor outlet nozzle 160a may define a second cover opening through which fuel vapor may be discharged to the vapor filter canister (for example, via a hose connected to the vapor outlet nozzle).

A generally cylindrical lower body portion 162 may extend from the base portion 156 in a second direction opposite the first direction. The lower body portion may have cylindrical outer wall 162a.

Referring to FIGS. 1 and 2, a pair of opposed latching ears 164 may extend from the lower body portion wall 162a. The latching ears 164 may be resiliently deflectable to engage associated latching tabs 104 formed on the lower case 50, to secure the cover 152 to lower case 50. The cover 152 may be formed from a polymer or any other suitable material or materials.

Referring again to FIGS. 1 and 3A, a weld pad 166 may be attached to cover 152 using a snap fit or any other suitable method. The weld pad 166 may enable the valve assembly to be attached to the inside of the vehicle fuel tank by welding the weld pad to a fuel tank interior wall. The weld pad 166 may be formed from a metallic material, a polymeric material, or any other suitable material.

A spring member 81 may be positioned in cavity 83. The spring member 81 may be structured to exert a force on the float assembly in the direction indicated by arrow A1, to supplement the buoyant force acting on the float assembly as the liquid fuel level in the lower case rises. To this end, the spring member may be structured to be always in compression.

In one or more arrangements, the spring member 81 may be a coil spring. A first end 81a of the spring member pushes against (and is always in contact with) ends of the recesses 66r and 68r, while an opposite, second end 81b of the spring member pushes against (and is always in contact with) the floor 70. The spring member 81 may be structured so that the force exerted by the compressed spring when the float assembly 80 is in contact with floor 70 is insufficient to lift the float assembly 80 without assistance from the buoyant force exerted on the float assembly by the rising fuel level in the lower case interior.

Referring to FIGS. 3A-5, to assemble the valve assembly 20, middle float 134 may be inserted into lower float cage structure 132. Seal member 122 may be mounted on upper float 136. Upper float 136 may then be mounted onto lower float cage structure 132. Core float 66 may be inserted into lower float 68. The lower float 68 may then be inserted into the lower case 50. The upper case 100 may then be mounted on top of the lower case 50. The cover 152 may then be applied to secure the upper case 100 to the lower case using resiliently deflectable latching ears 164.

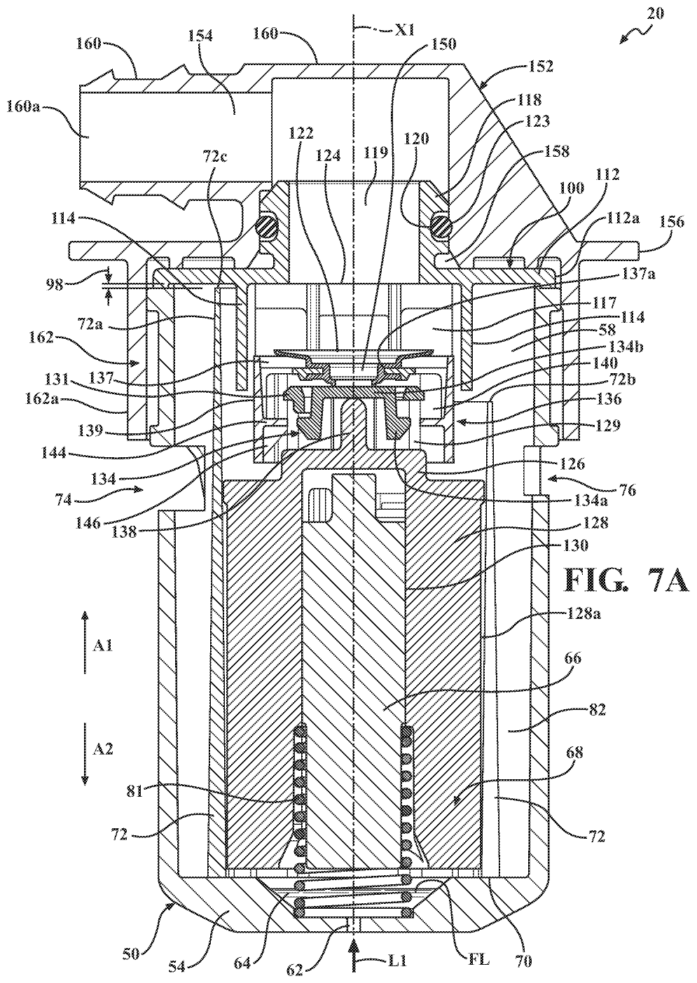

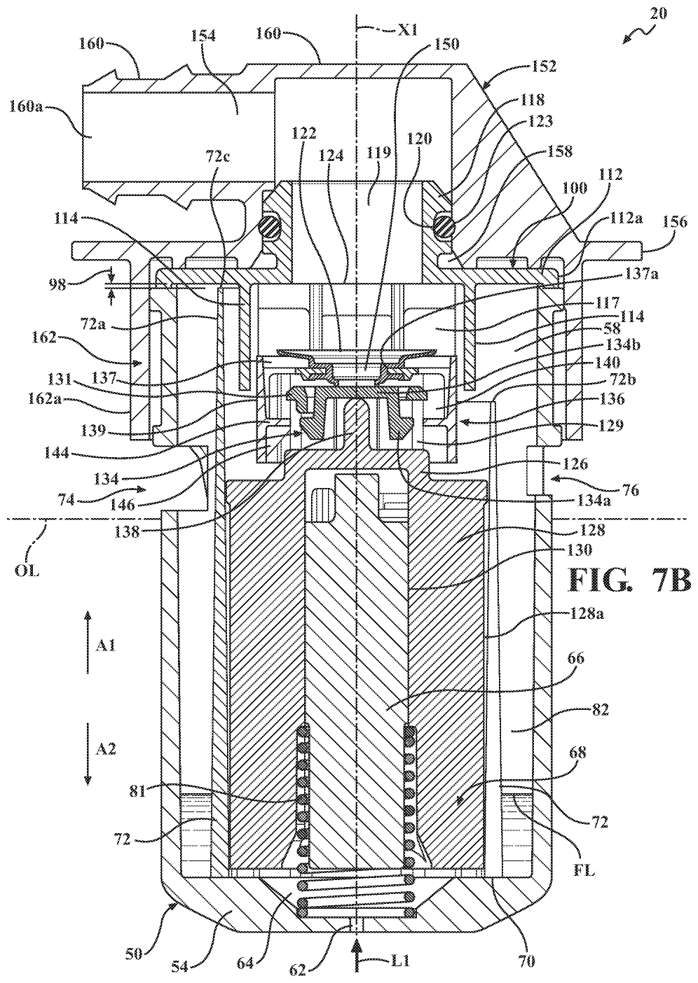

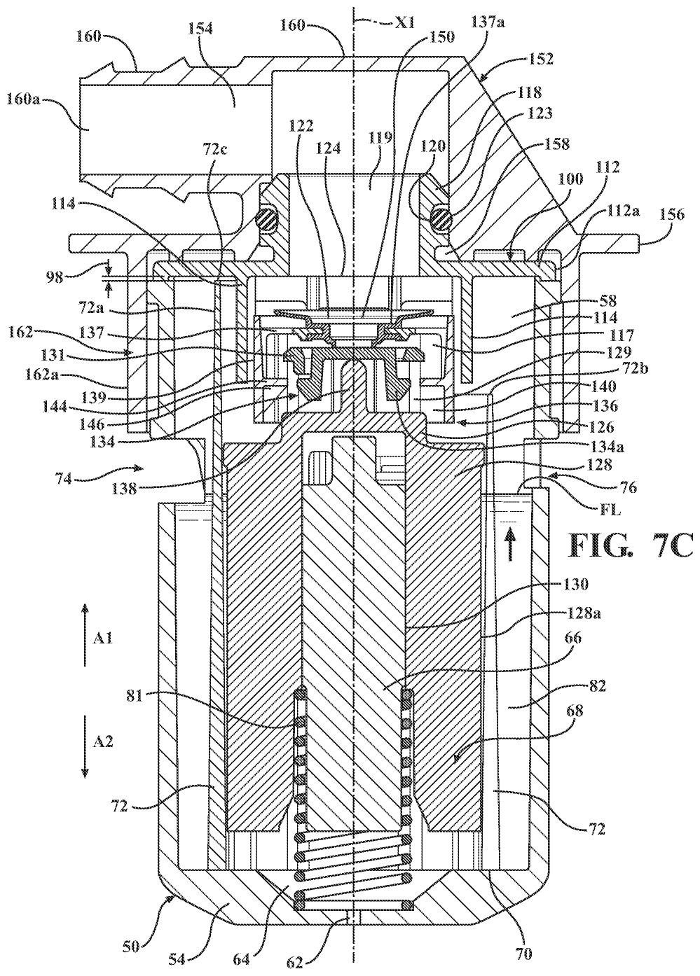

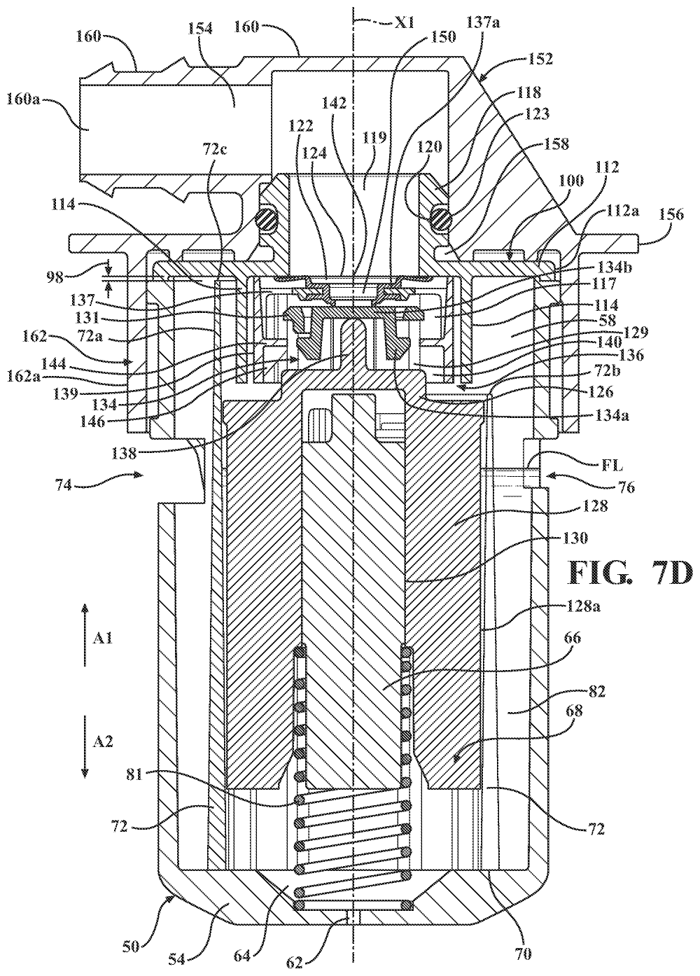

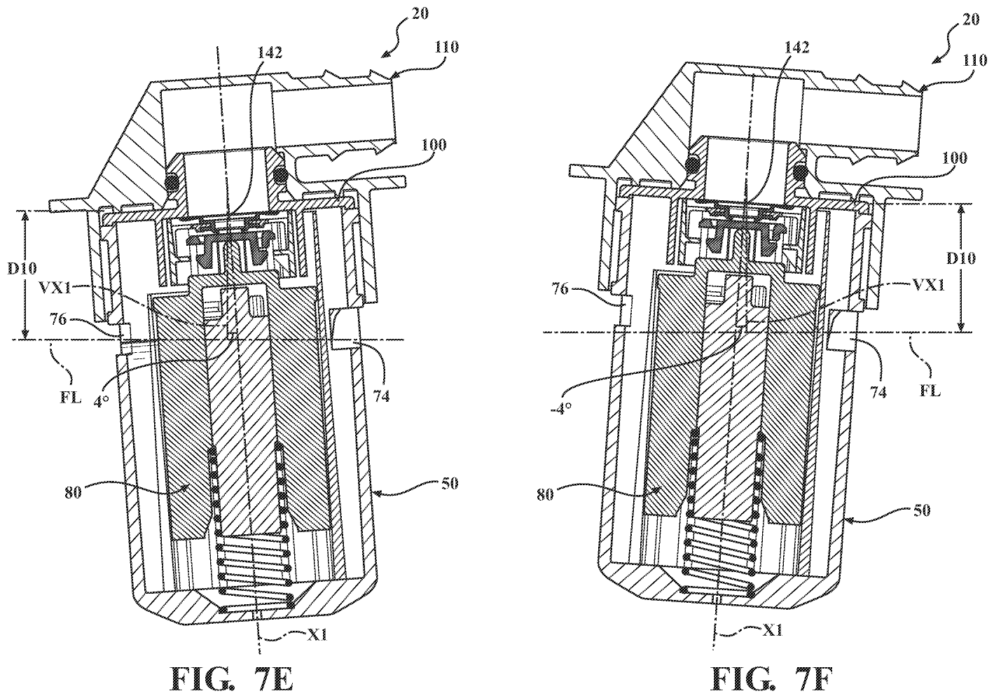

FIGS. 7A-7D are schematic cross-sectional views of the valve assembly shown in the previous drawings, showing operation of the valve assembly as the vehicle fuel tank fuel level rises and the valve assembly closes during vehicle refueling.

FIG. 7A is a schematic cross-sectional side view similar to FIG. 4 showing the valve assembly in a completely open condition just as fuel begins to enter the lower case through the lower case base portion hole. Referring to FIG. 7A, when liquid fuel begins to enter the vehicle fuel tank, the valve assembly is in the open configuration shown in FIG. 7A, with the float assembly 80 resting on the lower case base portion floor 70. In this condition, the upper float 136 is separated from the upper case base portion hole 124. Prior to the tank fuel level reaching the valve assembly 20, fuel vapor may enter the valve assembly through first and second slots 74 and 76 and into the lower case interior cavity 58 as indicated by arrows V1, V2 (FIGS. 6A-6C). The fuel vapors may proceed upwardly in the interior of the open valve assembly, through the spaces between stalks 114 of the upper case cage structure 117 as indicated by arrows V1, V2. The vapors may then flow through upper case base portion hole 124, into the upper case vapor passage 119 and into the vapor flow passage 154.

“FL” represents the fuel level inside the lower case 50. In FIG. 7A, when fuel entering the fuel tank reaches the lower case base portion hole 62, liquid fuel may begin to enter the lower case interior cavity 58 through the hole 62 as indicated by arrow L1 (FIG. 6A). Liquid L1 entering the lower case through hole 62 may rise within chamfered section 64 until it reaches base portion floor 70, at which point the fuel may begin to exert a buoyant force (acting in direction A1) on the core float 66 and the lower float 68.

Referring to FIG. 7B, as the liquid level in the lower case continues to rise through liquid fuel entering hole 62, the buoyant force acting on the float assembly 80 gradually increases. The flow of fuel vapor out of the lower case through the seal member passage 150 formed in seal member 122 and through upper case base portion hole 124 continues. Due to the relatively small size of the hole 62, the lower case interior fuel level FL will rise at a much slower rate that the fuel level OL on the exterior of the lower case rises, until the exterior fuel level reaches the first slot 74.

Referring now to FIG. 7C, as the liquid fuel level in the tank continues to rise, liquid fuel may continue to enter the lower case through base portion hole 62. When the liquid fuel level reaches first slot 74, liquid fuel L2 (FIG. 6A) enters the lower case 50 through slot 74, rapidly filling the lower case interior. The force exerted by the spring member 81 may lower the buoyant force needed to start moving the float assembly 80 from the floor 70 in direction A1. The combination of the spring force and the buoyant force exerted on the float assembly 80 causes the float assembly to start to rise off of floor 70. Lower float 68, middle float 134, upper float 136/seal member 122 remain in contact as the float assembly rises in the lower case interior. Lower float projection 138 exerts upward pressure on middle float base portion 134b, forcing middle float 134 upward. Middle float 134 exerts upward pressure on seal member 122, forcing the seal member and upper float 136 upward.

In a valve assembly structured to admit liquid fuel into the valve through an opening in a side wall of the case (such as first slot 74), a portion of the fuel entering the opening may splash or be deflected upwardly while the valve is open, thereby admitting liquid fuel into the vapor exit passage 119 before the valve can close. If liquid fuel enters the vapor passage and comes in contact with the vapor filter, it may damage the fuel vapor filter, which is designed only for contact with fuel vapor and not for contact with fuel in liquid form. It has been found that incorporation of a flow diverter 72a as described herein causes fuel entering the lower case 50 through first slot 74 to move downwardly after entering the lower case 50 as shown in FIG. 6A and to split into two flow branches along the flow diverter, as indicated by arrows L2 of FIG. 6C. The liquid fuel flow may proceed along flow channel 96 (between flow diverter 72a and outer wall 56) in the directions indicated by arrows L2 until opposite side edges 72x and 72y of the flow diverter 72a are reached by the branches of the fuel flow. The liquid fuel may then continue to flow along channel 82 (between inner wall 72 and outer wall 56) until it reaches opposed edges 88 and 90 of inner wall 72. The converging flows of liquid fuel may then enter the lower float interior cavity 78 through inner wall gap 86 and contact the float assembly 80, thereby gradually increasing the buoyant force acting on the elements of the float assembly. Thus, the flow diverter 72a may dissipate the energy of the fuel flow L2 entering the lower case while directing the fuel away from the vapor passages located in the upper portion of the valve assembly. This prevents liquid fuel from entering the vapor passages where it may possibly damage the vapor filter.

Referring to FIG. 7D, as the liquid fuel level in the lower case continues to rise, the lower float projection 138 presses the middle float 134 against the upper float seal 122, thereby sealing the passage 150 to vapor flow. Also, the upward pressure by the middle float 134 on the seal member 122 deforms the seal member to increase pressure at the interface between the seal member 122 and the upper case 100. This effectively seals the hole 124 against vapor flow. The valve assembly is completely sealed now that both hole 124 and passage 150 are blocked.

The valve assembly is now in a fully closed condition. When the valve assembly is in the fully closed condition as shown in FIG. 7D, the openings leading into the vapor passage 119 are sealed so as to prevent the flow of both fuel vapor and liquid fuel into the vapor passage 119.

Referring now to FIGS. 7E and 7F, FIG. 7E shows a schematic side cross-sectional view of the valve assembly 20 similar to the view of FIG. 7D, with the valve assembly tilted at an angle of 4° to the vertical axis VX1 and at a direction along the plane X4 of FIG. 6B. FIG. 7F shows a schematic side cross-sectional view of the valve assembly 20 similar to the view of FIG. 7D, with the valve assembly tilted at an angle of −4° to the vertical axis VX1 and at a direction along the plane X4 of FIG. 6B opposite to the direction of FIG. 7E.

While the valve assembly 20 may be installed in a vehicle so that it is oriented vertically as shown in FIGS. 4 and 7D when the vehicle resides on a level road surface, there are situations where the valve assembly may be tilted at an angle. For example, the vehicle containing the valve assembly may be parked on a sloped surface when the fuel tank is being filled. When the valve assembly 20 is tilted away from the vertical orientation shown in FIG. 4, the internal fuel level FL at which the valve fully closes during refueling may vary, depending on the angle of tilt and the direction of tilt. It is important for the valve assembly 20 to close and seal properly during refueling when it is in a non-vertical orientation. It is also important for the valve assembly to remain in the fully closed condition immediately or soon after refueling on a sloped surface, and after the vehicle has returned to a level surface and the valve assembly has returned to the vertical orientation. Thus, for refueling on a sloped surface, the valve assembly may be structured to fully close at an internal fuel level of the lower case which will maintain the valve assembly in a fully closed condition after the valve assembly has returned to the vertical orientation.

A problem with previous valve assembly designs is a relatively wide variation in the internal fuel level at which the valve assembly fully closes, depending on the angle at which the valve assembly is tilted from vertical and the direction of tilt. In the embodiments described herein, the valve assembly 20 may be maintained in the fully closed condition by ensuring that the fuel level FL inside the lower case remains at least a predetermined minimum level. To maintain full closure, it has been found desirable to minimize the variability of a dimension D10 extending vertically from a location 142 on the central axis X1 where the axis enters the vapor exit passage 119, to the fuel level FL inside the lower case when the valve assembly 20 achieves the fully closed condition.

Referring to FIGS. 7E and 7F, in particular arrangements, the valve assembly 20 may be structured to fully close during refueling at an internal fuel level FL of D10 when the valve assembly is tilted at an angle up to and including 4° from the vertical in any direction, and to remain in the fully closed condition after the internal fuel level is adjusted due to the vehicle moving from a sloped surface to a level (i.e., horizontal) surface.

It has been found that providing the slot 76 opposite the slot 74 (which is the main slot enabling fill of the lower case interior as the tank fuel level rises) minimizes the variability of the fuel level D10 at which the valve assembly closes when the valve assembly is tilted away from a vertical condition as described herein. It has also been found that, in a lower case 50 having the dual-slot structure described herein, the lower case internal fuel level FL is less sensitive to the direction of tilt of the valve assembly away from the axis X1. The exact value and range of the dimension D10 desired for achieving and maintaining full closure of the valve assembly when the valve fills on a sloped surface of up to ±4° from the vertical may be determined analytically and/or iteratively through experimentation for a given valve assembly design.

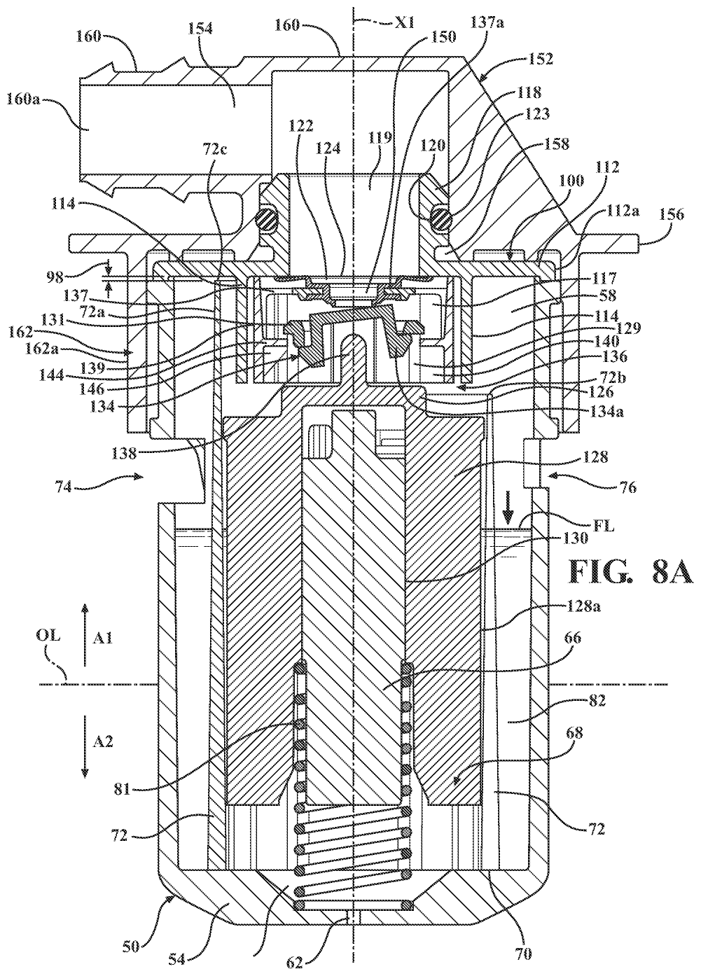

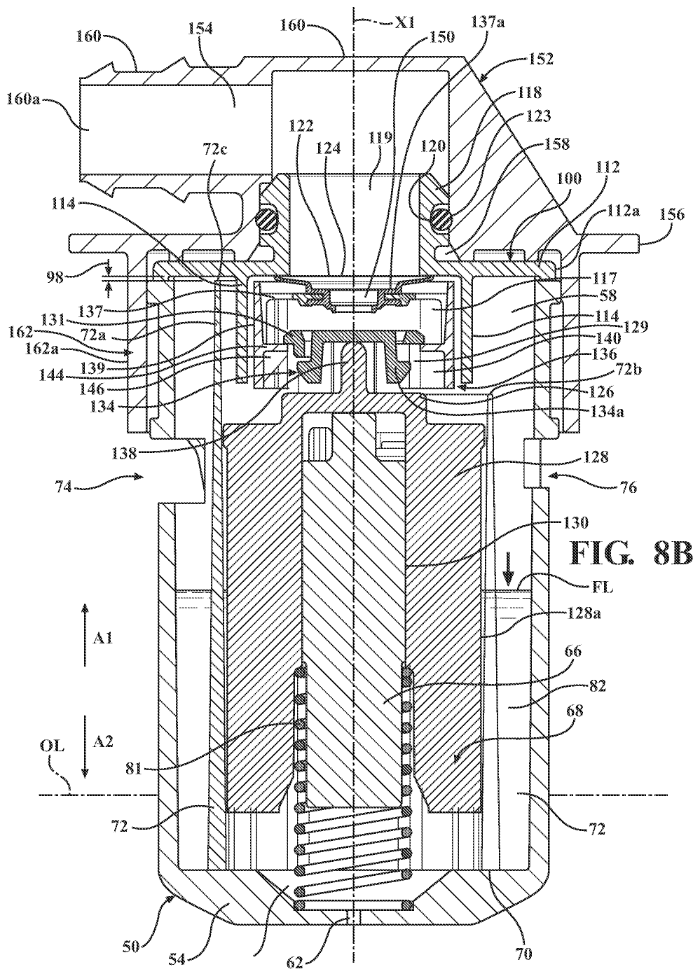

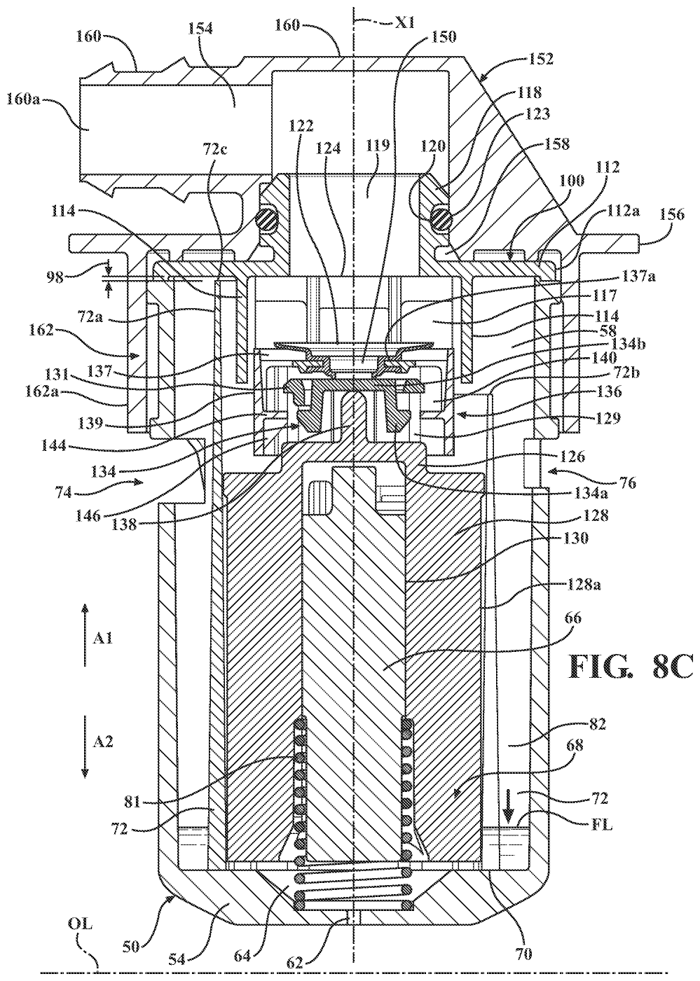

FIGS. 8A-8C are schematic cross-sectional views of the valve assembly showing operation of the valve assembly as the fuel in the tank is depleted and the valve assembly opens as the vehicle fuel tank fuel level falls.

FIG. 8A shows a view similar to that shown in FIG. 7D after the lower case internal fluid level FL has dropped below the slots 74 and 76. As the liquid fuel level in the lower case drops, the lower float 68 and core float 66 begin to descend within the lower case cavity 58. As the lower float 68 descends, lower float projection 138 disengages from the middle float 134 so that it no longer exerts upward force on the middle float. Then, the lower float connecting portion 131 may contact one or more of the middle float detents 134a. Pressure by the lower float connecting portion 131 in direction A2 on the middle float detent(s) 134a causes the middle float to begin to separate from the seal 122 as shown, at least partially unsealing the passage 150. This permits fuel vapor to flow through the passage 150.

Referring to FIG. 8B, further downward motion of the lower float 68 then causes the middle float connecting portion 131 to push downwardly on the detents 134a, thereby forcing the middle float 134 out of contact with the upper float seal member 122. Further downward motion of the lower float 68 then causes the middle float connecting portion 131 to push further downwardly on the detents 134a, thereby forcing the middle float 134 out of contact with the upper float seal member 122 and completely unsealing the passage 150. Still further downward motion of lower float 68 (in direction A2) brings the connecting portion 131 into contact with the upper float ledge 144.

Referring to FIG. 8C, after the connecting portion 131 has come into contact with the upper float ledge 144, further motion of lower float 68 in direction A2 presses downwardly on the upper float ledge, forcing the upper float 136 and the seal member 122 out of contact with the upper case 100 and opening the upper case base portion hole 124 to duel vapor flow therethrough. As the fuel level FL continues to drop, the float assembly continues to descend until the pre-filling configuration of FIG. 7A is reached.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8C, but the embodiments are not limited to the illustrated structure or application.

It will be appreciated that for simplicity and clarity of illustration, where appropriate, reference numerals have been repeated among the different figures to indicate corresponding or analogous elements and/or features. In addition, similar reference numerals in different figures refer to elements common to the different figures. Also, numerous specific details are set forth in order to provide a thorough understanding of the embodiments described herein. However, it will be understood by those of ordinary skill in the art that the embodiments described herein can be practiced without these specific details.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope of the invention.

1. A fluid limit vent valve assembly comprising a lower case including:
a base portion including a hole formed therein, the hole being sized to enable a predetermined flowrate of liquid fuel therethrough into the lower case;
an outer wall extending in a first direction from the base portion to define a lower case interior cavity and an end opening at an end of the lower case opposite the base portion;
an inner wall extending in the first direction from the base portion and opposite the outer wall;
a first slot extending through the outer wall;
a fuel flow diverter positioned in the lower case interior cavity directly opposite the first slot and along a path between the first slot and a vapor exit passage extending through an upper case of the valve assembly, the fuel flow diverter extending from an uppermost edge of the inner wall to a location spaced apart from the end opening; and
a second slot extending through the outer wall and angularly spaced apart from the first slot.

2. The valve assembly of claim 21, wherein the flow diverter is structured to extend from an upper case of the valve assembly to a location below a level of a lower edge of the first slot.

3. The valve assembly of claim 1 wherein the first and second slots are structured so that a lowermost edge of the first slot is vertically lower than a lowermost edge of the second slot when the valve assembly is in a vertical orientation.

4. The valve assembly of claim 1, further comprising an inner wall extending from the base portion, wherein the flow diverter is structured to extend from a first end intersecting the inner wall to a second end opposite the first end and residing at a location between the end opening and an edge of the first slot closest to the lower case end opening.

5. The valve assembly of claim 4 wherein the flow diverter is formed as a single piece with the inner wall.

6. The valve assembly of claim 4 wherein the flow diverter is supported only by the inner wall.

7. The valve assembly of claim 1 wherein the flow diverter is semi-cylindrical.

8. The valve assembly of claim 7 wherein the flow diverter extends only through an arc length in a range of 65°±5° to either side of a plane extending along a longitudinal central axis of the lower case and including a central axis of the first slot.

9. The valve assembly of claim 1 wherein the flow diverter is structured to be spaced apart a distance of up to of 4 millimeters inclusive from the lower case end opening.

10. The valve assembly of claim 1 wherein the first slot has a first width and the second slot has a second width less than the first width.

11. The valve assembly of claim 1 wherein a central axis of the second slot is angularly spaced apart a distance of 180°±5° from a central axis of the first slot.

12. The valve assembly of claim 1 further comprising an upper case structured to be mountable to the lower case to close the end opening of the lower case, the upper case including a base portion, and wherein the flow diverter is structured to be spaced apart extend a distance of up to of 2 millimeters inclusive from the upper case base portion when the upper case is mounted to the lower case.

13. The valve assembly of claim 12 wherein the upper case includes a first wall structured to extend from the upper case base portion in a first direction to define an interior cavity of the upper case extending into the lower case interior cavity when the upper case is mounted to the lower case.

14. The valve assembly of claim 13 wherein the upper case includes a second wall extending from the upper case base portion in a second direction opposite the first direction to define the vapor exit passage through the upper case, and wherein a through hole is formed in the base portion to enable fluid communication between the upper case interior cavity and the vapor passage.

15. (canceled)

16. The valve assembly of claim 24 wherein the upper case includes a base portion and a hole extending through the base portion, wherein the upper float includes a resilient seal member mounted thereon, the seal member being structured to seal the upper case base portion hole when the upper float is in contact with the upper case base portion, wherein the seal member has a passage extending therethrough, wherein the valve assembly further comprises a middle float structured to be movable into contact with the seal member to seal the seal member passage responsive to a rise in a liquid fuel level in the lower case interior cavity, and wherein the valve assembly further comprises a lower float including a projection structured to contact a portion of the middle float so as to urge the middle float against the seal member to maintain the middle float in contact with the seal member so as to seal the seal member passage.

17. (canceled)

18. (canceled)

19. (canceled)

20. The valve assembly of claim 16 wherein the upper float includes a ledge structured to contact a portion of the lower float during movement of the lower float in an opening direction of the valve assembly, so that movement of the lower float in the opening direction produces a movement of the upper float in the opening direction when the ledge is in contact with the lower float, thereby separating the seal member from the upper case base portion to unseal the upper case base portion hole.

21. A fluid limit vent valve assembly comprising a lower case including:
a base portion;
an outer wall extending from the base portion to define a lower case interior cavity and an end opening at an end of the lower case opposite the base portion;
a first slot extending through the outer wall;
a second slot extending through the outer wall and angularly spaced apart from the first slot;
an inner wall extending from the base portion and radially inwardly of the outer wall; and
an inner wall gap formed in the inner wall and extending from the base portion opposite and facing the second slot.

22. The valve assembly of claim 21 wherein a width of the second slot is less than a width of the first slot.

23. A fluid limit vent valve assembly comprising:
a lower case including a base portion, an outer wall extending from the base portion to define a lower case interior cavity, and a first slot extending through the outer wall;
an upper case;
a cage structure extending from the upper case into the lower case interior cavity and surrounding an opening in the upper case leading into a vapor exit passage of the valve assembly; and
a fuel flow diverter extending from the upper case, the flow diverter being positioned directly opposite first slot and interposed between the first slot and the cage structure.

24. The valve assembly of claim 1 further comprising a cage structure extending from the upper case into the lower case interior cavity, the cage structure being structured to receive therein an upper float of the valve assembly during operation of the valve assembly.
